(19) United States
(12) Patent Application Publication
(10) Pub. No.: US 2016/0167074 A1
(43) Pub. Date: Jun. 16, 2016

(54) DENTIFRICE DISPENSER

(71) Applicant: COLGATE-PALMOLIVE COMPANY, New York, NY (US)

(72) Inventor: Scott Beckerman, South Orange, NJ (US)

(21) Appl. No.: 14/907,333

(22) PCT Filed: Jul. 25, 2013
(86) PCT No.: PCT/US2013/052061

§ 371 Date: Jan. 25, 2016

(51) Int. Cl. B05B 11/00; A47K 1/09; A47K 5/00

(52) U.S. Cl. CPC B05B 11/3057; A47K 5/00; A47K 1/09

(57) ABSTRACT

Dentifrice dispenser (1), comprising: an elongate container (10) defining a chamber (14) storing a dentifrice and having an opening (16) through which the dentifrice is dispensable from the chamber (14); a pump for pumping the dentifrice from the chamber (14) to an exterior of the container (10) through the opening (16); and an elongate handle (20) movably attached to the container (10) to operate the pump; wherein a longitudinal axis of the elongate handle (20) is at an angle of between 0 and 60 degrees to a longitudinal axis of the container (10) when the elongate handle (20) is at a rest position. Kit comprising the dentifrice dispenser (1) and a mount for attaching a toothbrush to the dentifrice dispenser (1).

### BACKGROUND

The present invention relates to a dentifrice dispenser and to a kit comprising a dentifrice dispenser.

It is known to provide dentifrice, such as toothpaste, in a tube. However, in order to dispense dentifrice from the tube, a user has to squeeze the tube. This can be difficult or impossible for users with low hand or finger strength, such as children, the elderly and people suffering from arthritis. It is also known to provide dentifrice in a dispenser comprising a pump. Typically, the pump is for pumping the dentifrice from a chamber of the dispenser to an exterior of the dispenser through an opening. While a dispenser comprising a pump typically carries out much of the work required to dispense the dentifrice, nevertheless a user still has to manually operate a mechanism to cause the pump to operate. Usually, a user has to have good hand or finger dexterity and/or strength in order to operate such a mechanism, which typically is not the case when the user is a child, elderly or an arthritis sufferer.

There is a need for a dentifrice dispenser that is easier to operate by users with reduced hand or finger dexterity and/or strength in order to dispense dentifrice. There also is a need for a dentifrice dispenser that helps a user dispense dentifrice onto the head of a toothbrush.

### BRIEF SUMMARY

An embodiment of the present invention provides a dentifrice dispenser, comprising: an elongate container defining a chamber storing a dentifrice and having an opening through which the dentifrice is dispensable from the chamber; a pump for pumping the dentifrice from the chamber to an exterior of the container through the opening; and an elongate handle movably attached to the container to operate the pump; wherein a longitudinal axis of the elongate handle is at an angle of between 0 and 60 degrees to a longitudinal axis of the container when the elongate handle is at a rest position.

Optionally, the longitudinal axis of the elongate handle is at an angle of between 0 and 45 degrees to the longitudinal axis of the container when the elongate handle is at the rest position. Further optionally, the longitudinal axis of the elongate handle is at an angle of between 0 and 30 degrees to the longitudinal axis of the container when the elongate handle is at the rest position.

Optionally, the elongate handle is pivotally attached to the container for rotation about a pivot axis. Further optionally, the elongate handle is movable about the pivot axis towards the container over an angle of up to 45 degrees from the rest position to operate the pump. Still further optionally, the elongate handle is movable about the pivot axis towards the container over an angle of up to 30 degrees from the rest position to operate the pump.

Optionally, the elongate handle has a longitudinal length of at least 5 cm. Further optionally, the length is at least 7 cm. Still further optionally, the length is at least 10 cm.

Optionally, the elongate handle is biased to the rest position.

Optionally, the opening and the elongate handle are on the same lateral side of the container.

Optionally, the container has an oval cross section. Further optionally, a major axis of the oval cross section is parallel to the pivot axis.

Optionally, the dentifrice dispenser further comprises a mount for attaching a toothbrush to the dentifrice dispenser.

Optionally, the mount is connected to the container. Further optionally, the mount is detachably connected to the container.

Optionally, the elongate handle and the mount are on the same lateral side of the container, and/or the opening and the mount are on the same lateral side of the container.

Optionally, one of the container and the mount comprises a hole and the other of the container and the mount comprises a stem that is retained or retainable in the hole.

Optionally, the mount comprises a clip for clipping to the toothbrush.

Optionally, the mount is for attaching the toothbrush to the dentifrice dispenser with the opening facing a head of the toothbrush.

Another embodiment of the present invention provides a kit, comprising: a dentifrice dispenser, comprising: an elongate container defining a chamber storing a dentifrice and having an opening through which the dentifrice is dispensable from the chamber, a pump for pumping the dentifrice from the chamber to an exterior of the container through the opening, and an elongate handle movably attached to the container to operate the pump, wherein a longitudinal axis of the elongate handle is at an angle of between 0 and 60 degrees to a longitudinal axis of the container when the elongate handle is at a rest position; and a mount for attaching a toothbrush to the dentifrice dispenser.

Optionally, the kit comprises a toothbrush attached to, or attachable to, the dentifrice dispenser by the mount.

Optionally, the mount is connected to the container. Further optionally, the mount is detachably connected to the container.

Optionally, the mount is connectable to the container. Further optionally, the mount is detachably connectable to the container.

Optionally, the elongate handle and the mount are on the same lateral side of the container, and/or the opening and the mount are on the same lateral side of the container.

Optionally, the mount comprises a clip for clipping to the toothbrush.

Optionally, the mount is for attaching the toothbrush to the dentifrice dispenser with the opening facing a head of the toothbrush.

Optionally, the longitudinal axis of the elongate handle is at an angle of between 0 and 45 degrees to the longitudinal axis of the container when the elongate handle is at the rest position. Further optionally, the longitudinal axis of the elongate handle is at an angle of between 0 and 30 degrees to the longitudinal axis of the container when the elongate handle is at the rest position.

Optionally, the elongate handle is pivotally attached to the container for rotation about a pivot axis.

Optionally, the elongate handle is movable about the pivot axis towards the container over an angle of up to 45 degrees from the rest position to operate the pump. Further optionally, the elongate handle is movable about the pivot axis towards the container over an angle of up to 30 degrees from the rest position to operate the pump.

Optionally, the elongate handle has a longitudinal length of at least 5 cm. Further optionally, the length is at least 7 cm. Still further optionally, the length is at least 10 cm.

Optionally, the elongate handle is biased to the rest position.

Optionally, the opening and the elongate handle are on the same lateral side of the container.

Optionally, the container has an oval cross section. Further optionally, a major axis of the oval cross section is parallel to the pivot axis.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a side view of a dentifrice dispenser according to a first exemplary embodiment of the present invention;

FIG. 2 shows a front view of the dentifrice dispenser of FIG. 1;

FIG. 3 shows a perspective view of the dentifrice dispenser of FIG. 1;

FIG. 4 shows a side view of the dentifrice dispenser of FIG. 1 including a toothbrush attached to a container of the dentifrice dispenser by a mount;

FIG. 5 shows a perspective view of the dentifrice dispenser of FIG. 4; and

FIG. 6 shows a perspective view of a dentifrice dispenser according to a second exemplary embodiment of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

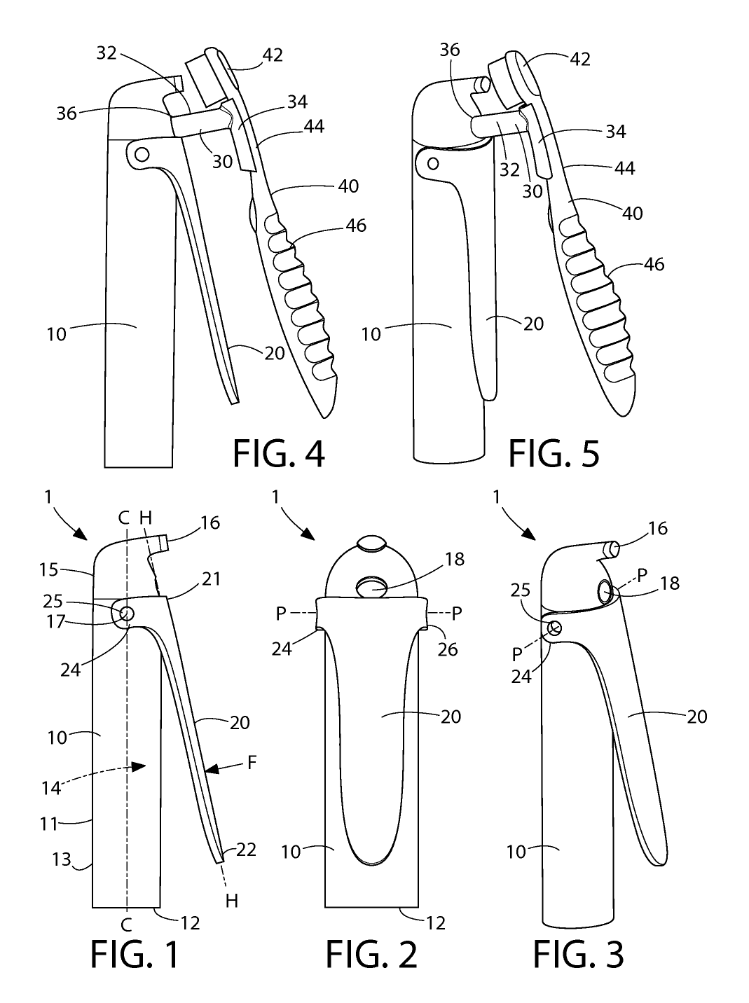

FIGS. 1 to 5 show a dentifrice dispenser 1 according to a first exemplary embodiment of the present invention. In short, the dentifrice dispenser 1 of the illustrated embodiment comprises a container 10, a pump (not shown), and a handle 20 movably attached to the container 10. Each of these components will be described in turn.

The container 10 comprises a body portion 11, which body portion 11 comprises a base 12 for stably standing the dispenser 1 on a substantially horizontal surface, and an elongate annular wall 13 extending from the base 12 and defining a chamber 14 therein. Within the chamber 14 there is stored a dentifrice (not shown). The container 10 also comprises a head portion 15 at an opposite longitudinal end of the wall 13 from the base 12, which head portion 15 defines an opening 16 through which the dentifrice is dispensable from the chamber 12.

The body portion 11 of the container 10 has a uniform oval cross section over its full length from the base 10 to its point of joining the head portion 15. In variations to the illustrated embodiment, the body portion 11 may have a different uniform cross sectional shape other than oval, such as circular or polygonal. Moreover, in variations to the illustrated embodiment, the body portion 11 may have a non-uniform cross section over its full length. For example, the body portion 11 may include one or more waists, indented portions or projecting portions, for aiding a user's grip of the container 10.

The container 10 has a longitudinal axis C-C that extends through the base 12 and the head portion 15 substantially parallel to, or coincident with, each of the central axis of the annular wall 13 and the centre of the oval cross section of the body portion 11. In the illustrated embodiment the base 12 is flat or substantially flat, and the longitudinal axis C-C of the container 10 extends in a direction that is perpendicular to a plane in which the base 12 lies. The opening 16 of the head portion 15 faces away from the longitudinal axis C-C of the container 10 towards a lateral side of the container 10.

The body portion 11 of the container 10 may have been formed by blow injection molding a material, by extruding a material to form the wall 13 and then attaching the base 12, or by some other process. The head portion 15 of the container 10 may have been formed by injection molding a material, or by some other process. The body portion 11 may be unitary with, that is integrally formed with, the head portion 15, or the body and head portions 11, 15 may have been formed separately as distinct components and joined to each other after their independent formation during manufacture of the dispenser 1. Preferably, each of the body portion 11 and the head portion 15 of the container 10 is rigid or hard. However, alternatively, either one or both of the body portion 11 and the head portion 15 may be flexible. The container 10 may be less rigid or hard than the handle 20, or the container 10 and the handle 20 may be approximately equally rigid or hard.

The dentifrice preferably is a fluid dentifrice, such as a paste or gel. The dentifrice may comprise toothpaste or a tooth cleaning or tooth polishing gel. Herein, by “fluid” it is meant that the dentifrice is flowable at room temperature and atmospheric pressure. Moreover, herein, by “room temperature” it is meant a temperature of 20 to 25 degrees Celsius, and by “atmospheric pressure” it is meant a pressure of 101 kPa.

The pump is a manually operable (i.e. unpowered) pump within the container 10. The pump could take the form of any manually operable pump known in the art, so long as the pump is suitable for pumping the dentifrice from the chamber 14 to an exterior of the container 10 and the dispenser 1 through the opening 16 when operated. The elongate handle 20 is operably connected to the pump in order to operate the pump when the elongate handle 20 is moved relative to the container 10, as described more fully below.

As shown in FIGS. 2 and 3, the elongate handle 20 is pivotally attached to the container 10 for rotation about a pivot axis P-P. More specifically, the container 10 comprises a pair of pegs 17 (only one of which is visible in the Figures) protruding from opposite lateral sides of the body portion 11, each of which pegs 17 has a circular cross section in a respective plane parallel to the longitudinal axis C-C of the container 10 and with a centre of the circular cross section coincident with the pivot axis P-P. A pair of spaced-apart and substantially parallel arms 24, 26 depend from opposed lateral sides of the elongate handle 20 at a proximal end 21 of the elongate handle 20. Each of the arms 24, 26 has a circular hole 25 (only one of which is visible in the Figures) formed therein, each of which holes 25 receives a respective one of the pegs 17 with the centre of the hole 25 coincident with the pivot axis P-P. Accordingly, part of the body portion 11 of the container 10 is between the arms 24, 26 of the elongate handle 20. In the illustrated embodiment, each of the holes 25 is a through hole, but in other embodiments the holes 25 may be blind holes so that the pegs 17 are not visible in the fully assembled dispenser 1. The elongate handle 20 and the opening 16 of the head portion 15 of the container 10 are on the same lateral side of the container 10. The pivot axis P-P is perpendicular to and crosses the longitudinal axis C-C of the container 10. A major axis of the oval cross section of the body portion 11 is parallel to, or coincident with, the pivot axis P-P, whereas a minor axis of the oval cross section of the body portion 11 is perpendicular to the pivot axis P-P. The elongate handle 20 has a longitudinal axis H-H that is perpendicular to the pivot axis P-P and the major axis of the oval cross section of the body portion 11, and that lies in the same plane as the minor axis of the oval cross section of the body portion 11 and the longitudinal axis C-C of the container 10. In this embodiment, a length of the elongate handle 20 in the direction of the longitudinal axis H-H between the proximal end 21 of the handle 20 and a distal, free end 22 of the elongate handle 20 furthest from the container 10 is about 10 cm. In variations to the illustrated embodiment, the length may be at least 5 cm, at least 7 cm or at least 10 cm. The length of the handle 20 in the direction of the longitudinal axis H-H is at least as great as the combined width of three or four adjacent fingers of the target users, which may for example be children of a certain age range, elderly people of a certain age range and/or of a certain sex, or arthritis sufferers of a certain age range and/or of a certain sex.

In FIGS. 1 to 4, the elongate handle 20 is shown at a rest position with the longitudinal axis H-H of the elongate handle 20 at an angle of approximately 15 degrees to the longitudinal axis C-C of the container 10, and with the distal end 22 of the elongate handle 20 further from the container 10 than the proximal end 21 of the elongate handle 20. When the elongate handle 20 is at the rest position relative to the container 10, application of a force on the handle 20 in the direction of the container 10 (as indicated by arrow F in FIG. 1) causes the elongate handle 20 to rotate about the pivot axis P-P relative to the container 10 over an angle of approximately 15 degrees, with the distal end 22 (indeed, all) of the elongate handle 20 moving towards the container 10, to an actuation position of the elongate handle 20 (see FIG. 5). As discussed above, the elongate handle 20 is operably connected to the pump. Such movement of the elongate handle 20 from the rest position to the actuation position causes operation of the pump, thereby to cause the dentifrice to be pumped from the chamber 14 to the exterior of the container 10 and the dispenser 1 through the opening 16.

In this embodiment, the elongate handle 20 is biased to the rest position by a resilient device (not shown) connected between the elongate handle 20 and the container 10. Accordingly, on having moved the elongate handle 20 to the actuation position, subsequent release or sufficient reduction of the force allows the resilient device to rotate the elongate handle 20 about the pivot axis P-P relative to the container 10, with the distal end 22 (indeed, all) of the elongate handle 20 moving away from the container 10, back to the rest position. In some embodiments, such movement of the elongate handle 20 from the actuation position to the rest position causes operation of the pump, thereby to cause more of the dentifrice to be pumped from the chamber 14 to the exterior of the container 10 and the dispenser 1 through the opening 16. Subsequent re-application and re-release of the force causes repetition of these motions, so that there is net movement of the dentifrice from the chamber 14 to the exterior of the container 10 and the dispenser 1 through the opening 16.

As mentioned above, the length of the elongate handle 20 in the direction of the longitudinal axis H-H is at least as great as the combined width of three or four adjacent fingers of the target users. Also, the handle 20 is movable relative to the container 10 with the distal end 22 (indeed, all) of the handle 20 moving towards and away from the container 10 to operate the pump. Accordingly, a target user is able to hold the dispenser 1 with the container 10 against the palm of one of their hands and with three or four of their fingers contacting the handle 20, and then to move the fingers towards the palm in order to squeeze the handle 20 towards the container 10 to operate the pump, thereby to dispense the dentifrice. The exaggerated length of the handle 20 provides the user with more leverage for manually operating the pump of the dispenser 1, and allows the force required to operate the pump to be spread over three or four fingers, rather than over only one finger as is known in the art. Therefore, the dentifrice dispenser 1 is easier to operate by users with reduced hand or finger dexterity and/or strength in order to dispense dentifrice.

Whereas in the illustrated embodiment the longitudinal axis H-H of the elongate handle 20 is at an angle of approximately 15 degrees to the longitudinal axis C-C of the container 10 when the elongate handle 20 is at the rest position, in variations to the illustrated embodiment the angle between the longitudinal axis H-H and the longitudinal axis C-C may be any angle between 0 and 60 degrees, or any angle between 0 and 45 degrees, or any angle between 0 and 30 degrees.

Moreover, whereas in the illustrated embodiment the elongate handle 20 is rotatable relative to the container 10 over an angle of approximately 15 degrees from the rest position to the actuation position to operate the pump, in variations to the illustrated embodiment the angle over which the elongate handle 20 is rotatable relative to the container 10 to move from the rest position to the actuation position to operate the pump may be any angle up to 60 degrees, or any angle up to 45 degrees, or any angle up to 30 degrees, or any angle up to 15 degrees.

While in the illustrated embodiment the handle 20 is pivotally attached to the container 10, in variations to the illustrated embodiment the handle 20 may be connected to the container 10 for translational movement relative to the container 10.

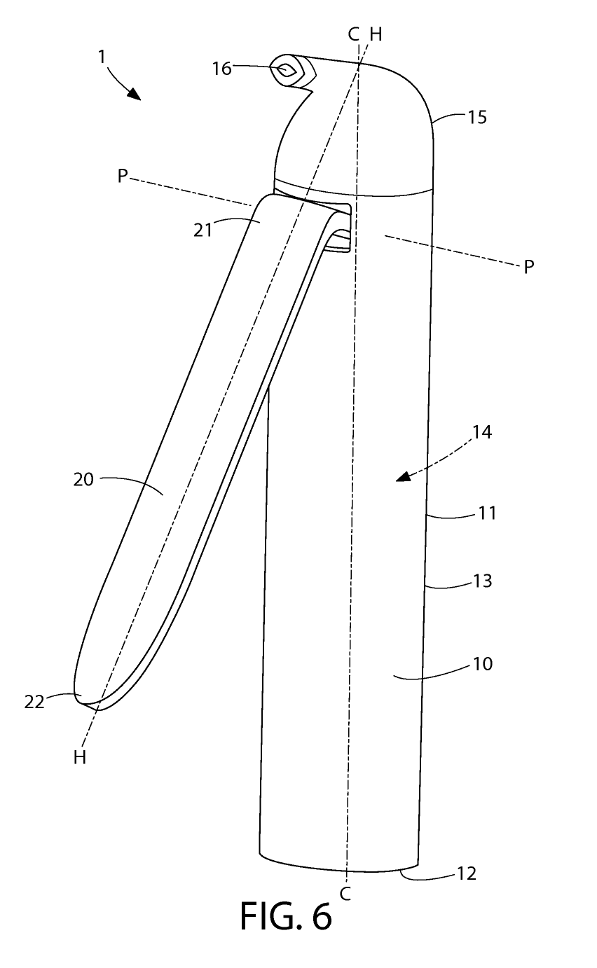

In variations to the illustrated first exemplary embodiment, the elongate handle 20 may be movably attached to the container 10 via different mechanisms. For example, the pegs 17 and arms 24, 26 may be omitted and the elongate handle 20 may be pivotally attached to the container 10 via a joint within the container 10 for rotation about a pivot axis P-P, as per the second exemplary embodiment shown in FIG. 6. In FIG. 6, the elongate handle 20 is operably connected to the pump (not shown) in order to operate the pump when the elongate handle 20 is moved relative to the container 10. More specifically, in FIG. 6, the elongate handle 20 is shown at a rest position with the longitudinal axis H-H of the elongate handle 20 at an angle of approximately 20 degrees to the longitudinal axis C-C of the container 10, and with the distal end 22 of the elongate handle 20 further from the container 10 than the proximal end 21 of the elongate handle 20. Movement of the elongate handle 20 from the rest position to the actuation position causes operation of the pump, thereby to cause the dentifrice to be pumped from the chamber 14 to the exterior of the container 10 and the dispenser 1 through the opening 16, in much the same way as for the first exemplary embodiment shown in FIGS. 1 to 4.

With reference to FIGS. 4 and 5, the dentifrice dispenser 1 of the illustrated first exemplary embodiment further comprises a mount 30 for attaching a toothbrush 40 to the dentifrice dispenser 1. The mount 30 comprises a stem 32 having a clip 34 at one longitudinal end thereof for clipping to a toothbrush 40. An opposite second longitudinal end 36 of the stem 32 from the longitudinal end having the clip 34 is retainable in a hole 18 comprised in the container 10, for detachably connecting the mount 30 to the container 10. The hole 18 is provided in the head portion 15 of the container 10, on the same lateral side of the container 10 as the opening 16 and the elongate handle 20, and between the opening 16 and the elongate handle 20.

The clip 34 and a neck 44 of the toothbrush 40 are relatively sized so that the clip 34 is able to clip to the neck 44 of the toothbrush 40 to attach the toothbrush 40 to the dentifrice dispenser 1 with the opening 16 facing a head 42 of the toothbrush 40. Moreover, the mount 30 has dimensions selected so that, when the toothbrush is attached to the dispenser 1 by the mount, the opening 16 faces the head 42 of the toothbrush 40 and is spaced from the head 42 of the toothbrush 40 by between 3 and 10 mm, more preferably about 5 mm. Since the head 42 is aligned with and close to the opening 16, the user need not be able to hold the toothbrush 40 steady relative to the container 10 when dispensing dentifrice. The user need focus only on moving the handle 20 relative to the container 10 to operate the pump, and indeed may use two hands to move the handle 20 relative to the container 10 to operate the pump. Therefore, the dentifrice dispenser 1 helps a user dispense dentifrice onto the head 42 of the toothbrush 40.

The dispenser 1 may be supplied with the second longitudinal end 36 of the stem 32 already retained in the hole 18, so that the mount 30 is connected, preferably detachably, to the container 10. In such an embodiment, the dispenser 1 may be supplied with the mount 30 detachably connected to the toothbrush 40, or the toothbrush 40 may be provided unconnected to the mount 30 but detachably attachable to the container 10 by the mount 30, or no toothbrush 40 may be provided with the dispenser 1. Alternatively, the dispenser 1 and the mount 30 may be provided unconnected to each other as a kit for assembly by the end user. Such a kit may or may not comprise the toothbrush 40. When the toothbrush 40 is included in the kit, the mount 30 may be detachably connected to the toothbrush 40, or the toothbrush 40 may be provided unconnected to the mount 30 but detachably attachable to the container 10 by the mount 30.

While in the illustrated first exemplary embodiment the hole 18 is comprised in the container 10, in a variation to the illustrated first exemplary embodiment the container 10 may comprise a stem that is retained or retainable in a hole comprised in the mount, for connecting the mount to the container 10. The stem of the container 10 preferably still would be provided on the same lateral side of the container 10 as the opening 16 and the elongate handle 20.

While in the illustrated first exemplary embodiment the clip 34 is sized to be able to clip to the neck 44 of the toothbrush 40 to attach the toothbrush 40 to the dentifrice dispenser 1, in variations to the illustrated first exemplary embodiment the clip 34 is sized to be able to clip to the head 42 or a handle 46 of the toothbrush 40 to attach the toothbrush 40 to the dentifrice dispenser 1. In further variations to the illustrated first exemplary embodiment, the mount 30 may comprise a device other than a clip for attaching the toothbrush 40 to the dentifrice dispenser 1.

In still further variations to the illustrated first exemplary embodiment, the mount 30 may be omitted. In such variations, the hole 18 or stem 32 also may be omitted from the container 10, as per the second exemplary embodiment shown in FIG. 6.

1. A dentifrice dispenser, comprising:
an elongate container defining a chamber storing a dentifrice and having an opening through which the dentifrice is dispensable from the chamber;
a pump for pumping the dentifrice from the chamber to an exterior of the container through the opening; and
an elongate handle movably attached to the container to operate the pump;
wherein a longitudinal axis of the elongate handle is at an angle of between 0 and 60 degrees to a longitudinal axis of the container when the elongate handle is at a rest position.

2. The dentifrice dispenser of claim 1, wherein the longitudinal axis of the elongate handle is at an angle of between 0 and 45 degrees to the longitudinal axis of the container when the elongate handle is at the rest position, optionally wherein the longitudinal axis of the elongate handle is at an angle of between 0 and 30 degrees to the longitudinal axis of the container when the elongate handle is at the rest position.

3. The dentifrice dispenser of claim 1, wherein the elongate handle is pivotally attached to the container for rotation about a pivot axis.

4. The dentifrice dispenser of claim 3, wherein the elongate handle is movable about the pivot axis towards the container over an angle of up to 45 degrees from the rest position to operate the pump, optionally wherein the elongate handle is movable about the pivot axis towards the container over an angle of up to 30 degrees from the rest position to operate the pump.

5. The dentifrice dispenser of claim 1, wherein the elongate handle has a longitudinal length of at least 5 cm, optionally wherein the length is at least 7 cm, further optionally wherein the length is at least 10 cm.

6. The dentifrice dispenser of claim 1, wherein the elongate handle is biased to the rest position.

7. The dentifrice dispenser of claim 1, wherein the opening and the elongate handle are on the same lateral side of the container.

8. The dentifrice dispenser of claim 1, wherein the container has an oval cross section.

9. The dentifrice dispenser of claim 8, wherein a major axis of the oval cross section is parallel to the pivot axis.

10. The dentifrice dispenser of claim 1, further comprising a mount for attaching a toothbrush to the dentifrice dispenser.

11. The dentifrice dispenser of claim 10, wherein the mount is connected to the container, optionally wherein the mount is detachably connected to the container.

12. The dentifrice dispenser of claim 10, wherein the elongate handle and the mount are on the same lateral side of the container, and/or wherein the opening and the mount are on the same lateral side of the container.

13. The dentifrice dispenser of claim 10, wherein one of the container and the mount comprises a hole and the other of the container and the mount comprises a stem that is retained or retainable in the hole.

14. The dentifrice dispenser of claim 10, wherein the mount comprises a clip for clipping to the toothbrush.

15. The dentifrice dispenser of claim 10, wherein the mount is for attaching the toothbrush to the dentifrice dispenser with the opening facing a head of the toothbrush.

16. A kit, comprising:
a dentifrice dispenser, comprising: an elongate container defining a chamber storing a dentifrice and having an opening through which the dentifrice is dispensable from the chamber, a pump for pumping the dentifrice from the chamber to an exterior of the container through the opening, and an elongate handle movably attached to the container to operate the pump, wherein a longitudinal axis of the elongate handle is at an angle of between 0 and 60 degrees to a longitudinal axis of the container when the elongate handle is at a rest position; and
a mount for attaching a toothbrush to the dentifrice dispenser.

17. The kit of claim 16, comprising a toothbrush attached to, or attachable to, the dentifrice dispenser by the mount.

18. The kit of claim 16, wherein the mount is connected to the container, optionally wherein the mount is detachably connected to the container.

19. The kit of claim 16, wherein the mount is connectable to the container, optionally wherein the mount is detachably connectable to the container.

20. The kit of claim 16, wherein the elongate handle and the mount are on the same lateral side of the container, and/or wherein the opening and the mount are on the same lateral side of the container.

21. The kit of claim 16, wherein the mount comprises a clip for clipping to the toothbrush.

22. The kit of claim 16, wherein the mount is for attaching the toothbrush to the dentifrice dispenser with the opening facing a head of the toothbrush.

23. The kit of claim 16, wherein the longitudinal axis of the elongate handle is at an angle of between 0 and 45 degrees to the longitudinal axis of the container when the elongate handle is at the rest position, optionally wherein the longitudinal axis of the elongate handle is at an angle of between 0 and 30 degrees to the longitudinal axis of the container when the elongate handle is at the rest position.

24. The kit of claim 16, wherein the elongate handle is pivotally attached to the container for rotation about a pivot axis.

25. The kit of claim 24, wherein the elongate handle is movable about the pivot axis towards the container over an angle of up to 45 degrees from the rest position to operate the pump, optionally wherein the elongate handle is movable about the pivot axis towards the container over an angle of up to 30 degrees from the rest position to operate the pump.

26. The kit of claim 16, wherein the elongate handle has a longitudinal length of at least 5 cm, optionally wherein the length is at least 7 cm, further optionally wherein the length is at least 10 cm.

27. The kit of claim 16, wherein the elongate handle is biased to the rest position.

28. The kit of claim 16, wherein the opening and the elongate handle are on the same lateral side of the container.

29. The kit of claim 16, wherein the container has an oval cross section.

30. The kit of claim 29, wherein a major axis of the oval cross section is parallel to the pivot axis.
